(19) United States
(12) Patent Application Publication
(10) Pub. No.: US 2014/0035760 A1
(43) Pub. Date: Feb. 6, 2014

(54) WATT-HOUR METER AND METHOD OF DETECTION OF ABNORMAL STATUS THEREOF

(71) Applicants: KOREA ELECTRIC POWER CORPORATION, Seoul (KR); SAMSUNG ELECTRO-MECHANICS CO., LTD., Suwon (KR)

(72) Inventor: Wan Cheol YANG, Suwon (KR)

(21) Appl. No.: 13/924,511

(22) Filed: Jun. 21, 2013

(30) Foreign Application Priority Data
Aug. 3, 2012 (KR) 10-2012-0085185

(51) Int. Cl. G01D 4/00

(52) U.S. Cl. CPC G01D 4/002
USPC 340/870.02

(57) ABSTRACT

There are provided a watt-hour meter capable of detecting an abnormal status due to the surreptitious use of electricity or electrical current leakage by vector synthesis of a three-phase current and a method of detection of an abnormal status thereof, the watt-hour meter including a sensing unit detecting alternating current (AC) power, an abnormal status detecting unit detecting an abnormal status by vector-synthesizing a current value of the AC power detected by the sensing unit, and a controlling unit controlling displaying of the abnormal status according to a detection result from the abnormal status detecting unit.

### CROSS-REFERENCE TO RELATED APPLICATION

This application claims the priority of Korean Patent Application No 10-2012-0085185 filed on Aug. 3, 2012, in the Korean Intellectual Property Office, the disclosure of which is incorporated herein by reference.

### BACKGROUND OF THE INVENTION

1. Field of the Invention

The present invention relates to a watt-hour meter capable of detecting an abnormal status due to the surreptitious use of electricity or electrical current leakage and a method of detection of an abnormal status thereof.

2. Description of the Related Art

Recently, electronic devices have been increasingly used in daily life due to increases in the diversity of functions contained therein, utilization by users, and other factors.

An example of an electronic device may include a meter for metering power, gas, water, or the like, supplied to a home, a building, or the like.

Such a meter has performed metering in a manner in which physical amounts of power, gas, water, or the like, which have been consumed, are read and a meter reader directly checks the meter with the naked eye to record consumption amounts and collect data related thereto to be transmitted to a central center.

In addition to this, in accordance with a development of communications technologies such as remote area wireless communications, data communications, and the like, an electronic meter, metering physical amounts of supplied power, gas, water, and the like, and transmitting data related to the metered physical amounts to a data collection center via a wired and wireless communications scheme, has been utilized.

The above-mentioned electronic meter, particularly, a watt-hour meter described in the related art, provides metered data to allow power consumption amounts to be accurately determined and users to be properly charged for their metered power consumption. However, an abnormal status, due to a problem such as electrical leakage due to a deteriorated or damaged electrical wiring in a facility or due to the surreptitious use of electricity, in which a user surreptitiously consumes power in order to avoid being charged for the use thereof, may be generated in such an electronic meter.

### RELATED ART DOCUMENT

Korean Patent Laid-open Publication No. 10-2009-0055782

### SUMMARY OF THE INVENTION

An aspect of the present invention provides a watt-hour meter capable of detecting an abnormal status due to the surreptitious use of electricity or electrical current leakage by vector synthesis of a three-phase current and a method of detection of an abnormal status thereof.

According to an aspect of the present invention, there is provided a watt-hour meter, including: a sensing unit detecting alternating current (AC) power; an abnormal status detecting unit detecting an abnormal status by vector-synthesizing a current value of the AC power detected by the sensing unit; and a controlling unit controlling displaying of the abnormal status according to a detection result from the abnormal status detecting unit.

The AC power may be single phase or three-phase four-wire AC power.

The abnormal status detecting unit may detect the abnormal status by comparing the vector-synthesized current of the AC power of each phase of the three-phase four-wire AC power with neutral wire current.

The abnormal status detecting unit may include: a first root mean square measuring unit measuring a root mean square of the alternating current power of each phase of the three-phase four wire AC power, a squaring unit squaring the root mean square of each phase measured by the first root mean square measuring unit; a multiplying unit alternately multiplying the alternating current in respective phases of the three-phase four-wire AC power; an integrating unit integrating each multiplied value from the multiplying unit; a first calculating unit increasing each integrated value of the integrating unit twice; a combining unit combining each squared value of the squaring unit with each calculated value of the first calculating unit; a root calculating unit root-calculating the combined value of the combining unit; a second root mean square measuring unit measuring a root mean square of the neutral wire current; and a second calculating unit comparing the calculated value of the root-calculating unit with the measured root mean square of the second root mean square measuring unit to calculate a difference therebetween.

The sensing unit may include: a current sensing unit detecting a current value of the AC power, and a voltage sensing unit detecting a voltage value of the AC power.

The watt-hour meter may further include a power calculating unit calculating a power amount based on the current value and the voltage value detected by the sensing unit.

The watt-hour meter may further include a display unit displaying the abnormal status according to the control of the controlling unit.

According to an aspect of the present invention, there is provided a method of detection of an abnormal status of a watt-hour meter, including: detecting alternating current (AC) power; detecting the abnormal status by vector-synthesizing the detected current value of the AC power; and displaying the abnormal status according to a detection result.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a watt-hour meter according to an embodiment of the present invention;

FIG. 2 is a schematic block diagram of an abnormal status detecting unit used in the watt-hour meter according to the embodiment of the present invention;

FIG. 3 is a flow chart showing a method of detection of the abnormal status of the watt-hour meter according to another embodiment of the present invention; and

FIGS. 4 through 6 are graphs showing electrical characteristics of the watt-hour meter according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

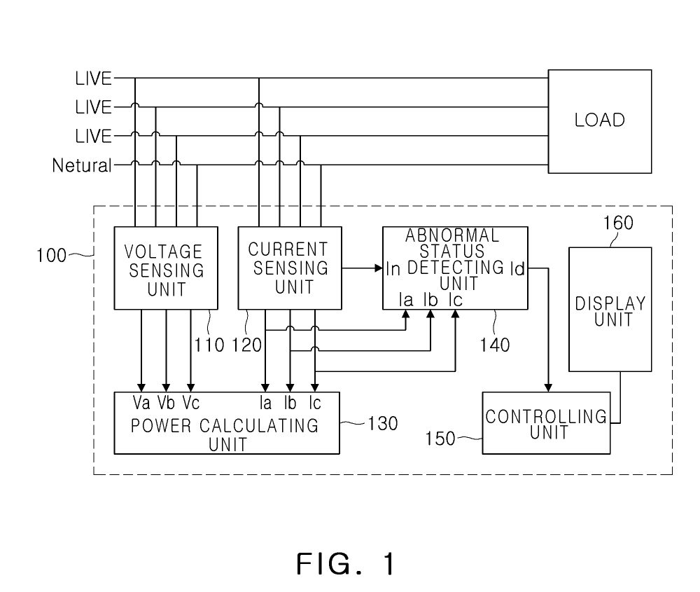

FIG. 1 is a schematic block diagram of a watt-hour meter according to an embodiment of the present invention.

Referring to FIG. 1, the watt-hour meter 100 according to the embodiment of the present invention may include sensing units 110 and 120, a power calculating unit 130, an abnormal status detecting unit 140, a controlling unit 150, and a display unit 160.

The sensing unit may include a voltage sensing unit 110 and a current sensing unit 120.

The voltage sensing unit 110 may detect a voltage level of alternating current (AC) power input to the watt-hour meter 100, and the current sensing unit 120 may detect a current level of the AC power input to the watt-hour meter 100.

The power calculating unit 130 may calculate a power amount used by a user based on the voltage level detected by the voltage sensing unit 110 and the current level detected by the current sensing unit 120.

The controlling unit 150 may control so that the power amount calculated by the power calculating unit 130 is accumulated and information necessary for a charge is transmitted to an external central processing unit.

Meanwhile, an abnormal status due to the surreptitious use of electricity or electrical current leakage may be generated during the use of power by the user or during the calculating operation of the watt-hour meter.

The abnormal status detecting unit 140 may vector-synthesize a current value detected by the current sensing unit 120 and detect an abnormal status of the watt-hour meter based on the vector-synthesized current.

The AC power may be single phase AC power and may also be three-phase four-wire AC power having three-phase, live wires corresponding to the three-phases and a single neutral wire.

Describing the three-phase four-wire AC power as an example, the abnormal status detecting unit 140 may detect the abnormal status according to a difference between the vector-synthesized current value of the detected three-phase current and a current value of the neutral wire.

To this end, the abnormal status detecting unit 140 may include the following components.

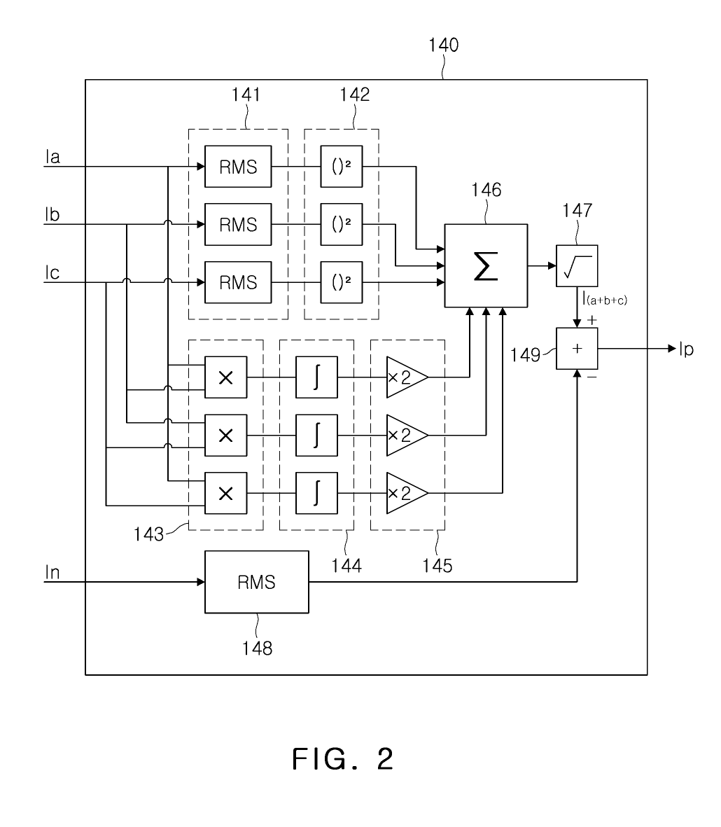

FIG. 2 is a schematic block diagram of an abnormal status detecting unit used in the watt-hour meter according to the embodiment of the present invention.

Referring to FIG. 2, the abnormal status detecting unit 140 may include a first root mean square measuring unit 141, a squaring unit 142, a multiplying unit 143, an integrating unit 144, a first calculating unit 145, a combining unit 146, a root calculating unit 147, a second root mean square measuring unit 148, and a second calculating unit 149.

The first root mean square measuring unit 141 may measure a root mean square (RMS) of the respective three-phase current values detected by the current sensing unit 120 from the three-phase four-wire AC power.

The squaring unit 142 may square the root mean square of each phase measured by the first root mean square measuring unit 141.

The multiplying unit 143 may alternately multiply the three-phase current values detected by the current sensing unit 120 from the three-phase four-wire AC power. For example, when the three-phase AC power has a, b, and c phases, an AC value of the a phase and an AC value of the b phase may be multiplied, the AC value of the b phase and an AC value of the c phase may be multiplied, and the AC value of the c phase and the AC value of the a phase may be multiplied.

The integrating unit 144 may integrate each multiplied value from the multiplying unit 143.

The first calculating unit 145 may increase each integrated value integrated by the integrating unit 144 twice.

The combining unit 146 may combine each squared value from the squaring unit 142 with each calculated value from the first calculating unit 145, and the root calculating unit 147 may root-calculate the value combined by the combining unit 146.

The second root mean square measuring unit 148 may measure a root mean square of current of the neutral wire from the three-phase four-wire AC power.

The second calculating unit 149 may compare the value calculated by the root calculating unit 147 with the measured root mean square from the second root mean square measuring unit 148 and may calculate a difference therebetween.

Meanwhile, the controlling unit 150 may control so that the abnormal status is displayed on the display unit 160 according to a detection result of the abnormal status detecting unit 140.

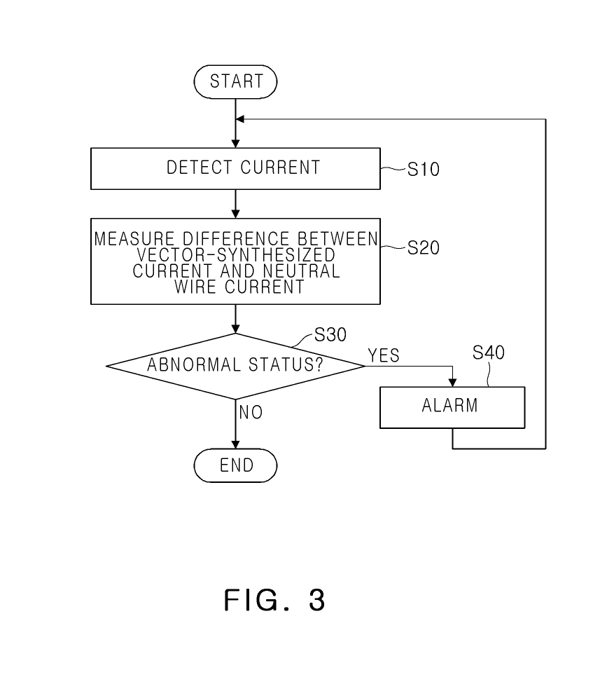

FIG. 3 is a flow chart showing a method of detection of the abnormal status of the watt-hour meter according to another embodiment of the present invention.

Referring to FIGS. 1 and 3, first, the current value of the three-phase AC power and the current value of the neutral wire of the three-phase four-wire AC power, respectively, may be detected by the current sensing unit 120 (S10).

Next, the abnormal status detecting unit 140 may compare the vector-synthesized current value of the three-phase AC power with the current value of the neutral wire power and may detect the abnormal status according to the comparison result (S20). Referring to FIG. 2, the abnormal status detecting operation (S20) may include performing a first root mean square measuring operation of measuring a root mean square of AC of each phase of the three-phase four-wire AC power by the first root mean square measuring unit 141, the squaring unit 142, the multiplying unit 143, the integrating unit 144, the first calculating unit 145, the combining unit 146, the root calculating unit 147, the second root mean square measuring unit 148, and the second calculating unit 149 of the abnormal status detecting unit 140; a squaring operation of squaring the root mean square of each phase measured by the first root mean square measuring operation; a multiplying operation of alternately multiplying AC in respective phases of the three-phase four-wire AC power; an integrating operation of integrating each multiplied value from the multiplying operation; a first calculating operation of increasing each integrated value of the integrating operation twice; a combining operation of combining each squared value of the squaring operation with each calculated value of the first calculating operation; a root-calculating operation of root-calculating the combined value of the combining operation; a second root mean square measuring operation of measuring root mean square of the neutral wire current; and a second calculating operation of comparing the calculated value of the root-calculating operation with the measured root mean square value of the second root mean square measuring operation to calculate a difference therebetween.

The controlling unit 150 may display the abnormal status on the display unit 160 when the current value corresponding to the difference between the current value of the three-phase AC power and the current value of the neutral wire power is a preset reference current value or more, and may maintain the operation when the current value corresponding to the difference between the current value of the three-phase AC power and the current value of the neutral wire power is equal to the preset reference current value or less (S30 and S40).

The detection method of the abnormal status detecting unit 140 described above may be developed in equations as follows.

First, the neutral wire current may be expressed in a vector sum of current of each phase as in the following Equation 1.

I_{N}=Ia+Ib+Ic (Equation 1)

Where, I_{N} represents the neutral wire current and Ia, Ib, and Ic represent currents of the a phase, the b phase, and the c phase, respectively.

This may be represented in the following Equation 2.

$${I}_{a + b + c} = \sqrt{( {( {I}_{a} cos a + {I}_{b} cos b + {I}_{c} cos c )}^{2} + {( {I}_{a} sin a + {I}_{b} sin b + {I}_{c} sin c )}^{2} )} \qquad ( Equation 2 )$$

where (a+b+c)²=a²+b²+c²+2ab+2bc+2ca

when substituting this into Equation 2, the following Equations 3 and 4 may be developed.

(Iₐ cos a)²+(I_{b} cos b)²+(I_{c} cos c)²+2IₐI_{b} cos a cos b+2I_{b}I_{c} cos b cos c+2IₐI_{c} cos a cos c (Equation 3)

(Iₐ sin a)²+(I_{b} sin b)²+(I_{c} sin c)²+2IₐI_{b} sin a sin b+2I_{b}I_{c} sin b sin c+2IₐI_{c} sin a sin c (Equation 4)

When summing Equations 3 and 4, the following Equation 5 may be obtained.

Iₐ²+I_{b}²+I_{c}²+2IₐI_{b}(cos a cos b+sin a sin b)+2I_{b}I_{c}(cos b cos c+sin b sin c)+2IₐI_{c}(cos a cos c+sin a sin c) (Equation 5)

When summarizing the equations above, the following Equation 6 may be obtained.

$$\begin{matrix} ( Equation 6 ) & \\ \begin{matrix}{I}_{a + b + c} = \sqrt{( {( {I}_{a} cos a + {I}_{b} cos b + {I}_{c} cos c )}^{2} + {( {I}_{a} sin a + {I}_{b} sin b + {I}_{c} sin c )}^{2} )} \\ = \sqrt{( \begin{matrix}{I}_{a}^{2} + {I}_{b}^{2} + {I}_{c}^{2} + 2 {I}_{a} * {I}_{b} * cos ( a - b ) + 2 {I}_{b} * {I}_{c} * \\ cos ( b - c ) + 2 {I}_{a} * {I}_{c} * cos ( a - c )\end{matrix} )}\end{matrix} & \end{matrix}$$

For example, when a phase difference between the respective phases is 120 degrees (a=0 degrees, b=120 degrees, and c=−120 degrees), the vector synthesized current may be simply represented as follows.

I_{a+b+c}=\sqrt{(Iₐ²+I_{b}²+I_{c}²−IₐI_{b}−I_{b}I_{c}−IₐI_{c})}

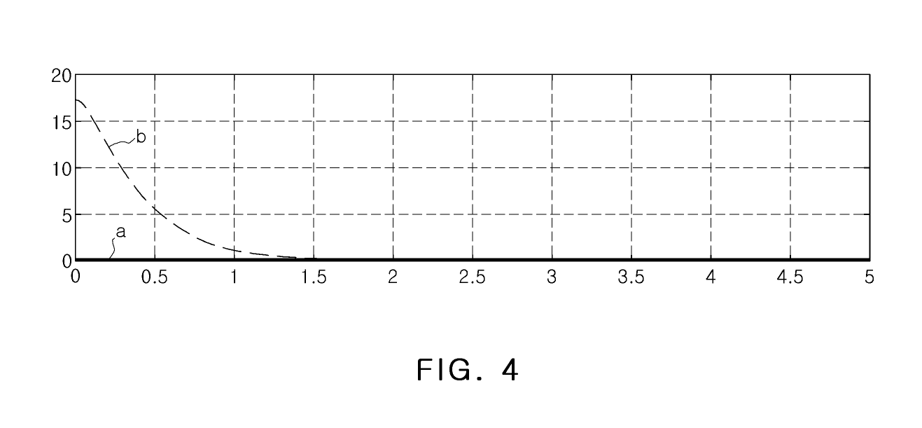

FIGS. 4 through 6 are graphs showing electrical characteristics of the watt-hour meter according to the embodiment of the present invention.

In FIG. 4, when the current of each phase of the three-phase current represents 10 ampere [A] and the phase difference represents 120 degrees (the a phase is 0 degrees, the b phase is 120 degrees, and the c phase is −120 degrees), the neutral wire current is in a balanced state and may have a value of ‘0’. The reference letter ‘a’ of FIG. 4 represents an ideal value and ‘b’ represents a measured value according to the embodiment of the present invention. As shown in FIG. 4, it may be appreciated that the measured value according to the embodiment of the present invention approximates the ideal value.

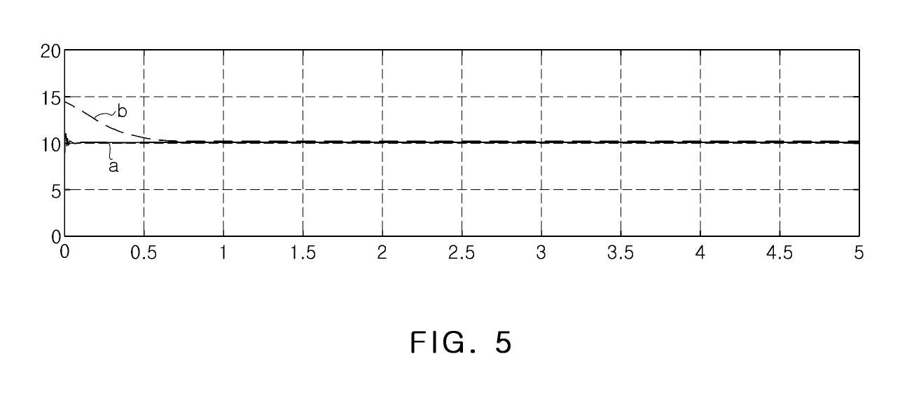

In FIG. 5, when the current of the a phase of the three-phase current represents 0 [A], the currents of the b phase and the c phase represent 10 [A], and the phase difference represents 120 degrees (the a phase is 0 degrees, the b phase is 120 degrees, and the c phase is −120 degrees), the neutral wire current is in a balanced state and may have a value of 10 [A]. The reference letter ‘a’ of FIG. 5 represents an ideal value and ‘b’ represents a measured value by the embodiment of the present invention. As shown in FIG. 5, it may be appreciated that the measured value according to the embodiment of the present invention approximates the ideal value.

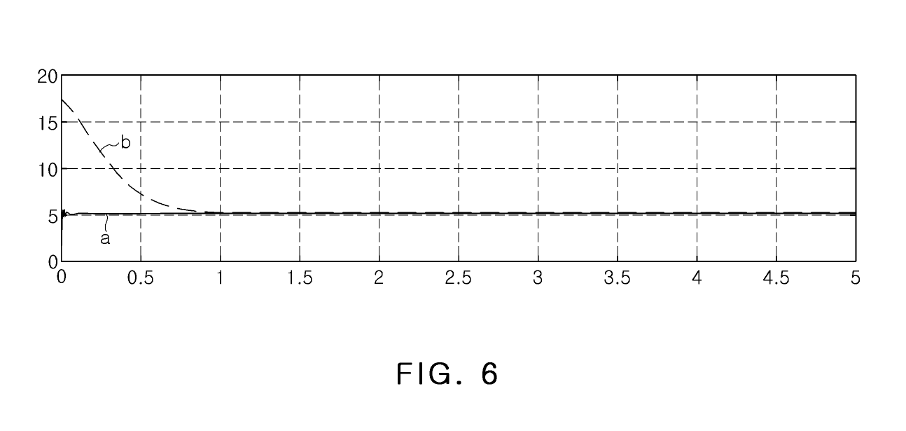

In FIG. 6, when the current of each phase of the three-phase current has the same current as 10 [A], but the phase difference is in an unbalanced state because the a phase is 0, the b phase is 90 degrees, and the c phase is −120 degrees, the neutral wire current may have a value of 5.1763 [A]. The reference letter ‘a’ represents an ideal value and ‘b’ of FIG. 6 represents a measured value by the embodiment of the present invention. As shown in FIG. 6, it may be appreciated that the measured value according to the embodiment of the present invention converges on the ideal value.

As set forth above, according to the embodiment of the present invention, an abnormal status due to the surreptitious use of electricity or electrical current leakage may be detected by vector synthesis of a three-phase current, such that the abnormal status due to the surreptitious use of electricity or electrical current leakage in a three-phase four-wire AC power system may be detected by a simplified circuit configuration.

While the present invention has been shown and described in connection with the embodiments, it will be apparent to those skilled in the art that modifications and variations can be made without departing from the spirit and scope of the invention as defined by the appended claims.

What is claimed is:

1. A watt-hour meter, comprising:
a sensing unit detecting alternating current (AC) power;
an abnormal status detecting unit detecting an abnormal status by vector-synthesizing a current value of the AC power detected by the sensing unit; and
a controlling unit controlling displaying of the abnormal status according to a detection result from the abnormal status detecting unit.

2. The watt-hour meter of claim 1, wherein the AC power is single phase or three-phase four-wire AC power.

3. The watt-hour meter of claim 2, wherein the abnormal status detecting unit detects the abnormal status by comparing the vector-synthesized current of the AC power of each phase of the three-phase four-wire AC power with neutral wire current.

4. The watt-hour meter of claim 3, wherein the abnormal status detecting unit includes:
a first root mean square measuring unit measuring a root mean square of the AC power of each phase of the three-phase four-wire AC power,
a squaring unit squaring the root mean square of each phase measured by the first root mean square measuring unit;
a multiplying unit alternately multiplying the alternating current in respective phases of the three-phase four-wire AC power;
an integrating unit integrating each multiplied value from the multiplying unit;
a first calculating unit increasing each integrated value of the integrating unit twice;
a combining unit combining each squared value of the squaring unit with each calculated value of the first calculating unit;
a root calculating unit root-calculating the combined value of the combining unit;
a second root mean square measuring unit measuring a root mean square of the neutral wire current; and
a second calculating unit comparing the calculated value of the root-calculating unit with the measured root mean square of the second root mean square measuring unit to calculate a difference therebetween.

5. The watt-hour meter of claim 1, wherein the sensing unit includes:
a current sensing unit detecting a current value of the AC power, and
a voltage sensing unit detecting a voltage value of the AC power.

6. The watt-hour meter of claim 5, further comprising a power calculating unit calculating a power amount based on the current value and the voltage value detected by the sensing unit.

7. The watt-hour meter of claim 1, further comprising a display unit displaying the abnormal status according to the control of the controlling unit.

8. A method of detection of an abnormal status of a watt-hour meter, comprising:
detecting alternating current (AC) power;
detecting the abnormal status by vector-synthesizing the detected current value of the AC power; and
displaying the abnormal status according to a detection result.

9. The method of detection of an abnormal status of a watt-hour meter of claim 8, wherein the AC power is single phase or three-phase four-wire AC power.

10. The method of detection of an abnormal status of a watt-hour meter of claim 9, wherein in the detecting of the abnormal status, the abnormal status is detected by comparing the vector-synthesized current of the AC power of each phase of the three-phase four-wire AC power with neutral wire current.

11. The method of detection of an abnormal status of a watt-hour meter of claim 10, wherein the detecting of the abnormal status includes:
performing a first root mean square measuring operation of AC of each phase of the three-phase four-wire AC power;
squaring the root mean square of each phase measured by the first root mean square measuring operation;
alternately multiplying the alternating current in respective phases of the three-phase four-wire AC power;
integrating each multiplied value from the multiplying;
performing a first calculating operation of increasing each integrated value from the integrating twice;
combining each squared value from the squaring of the root mean square with each calculated value of the first calculating operation;
root-calculating the combined value from the combining of the squared value with the calculated value of the first calculating operation;
performing a second root mean square measuring operation of the neutral wire current; and
performing a second calculating operation of comparing the calculated value from the root-calculating of the combined value with the measured root mean square of the second root mean square measuring operation to calculate a difference therebetween.
